(19) United States
(12) Patent Application Publication
(10) Pub. No.: US 2010/0182398 A1
(43) Pub. Date: Jul. 22, 2010

(54) 360 degree automobile video camera system

(76) Inventor: Joseph J. Mazzilli, Bellmore, NY (US)

Correspondence Address: RICHARD B. KLAR, 145 WILLIS AVENUE, SUITE NO. 6, MINEOLA, NY, 11501, US

(21) Appl. No.: 12/660,385

(22) Filed: Feb. 25, 2010

Related U.S. Application Data
(63) Continuation-in-part of application No. 11/064,613, filed on Feb. 24, 2005.
Application No. 11/064,613 is a continuation-in-part of application No. 10/227,170, filed on Aug. 23, 2002, now abandoned.
(60) Provisional application No. 61/208,866, filed on Feb. 28, 2009.

(51) Int. Cl. H04N 7/00

(52) U.S. Cl. 348/36; 348/E07.085; 348/E07.001

(57) ABSTRACT

The present invention relates to a video camera system which has a 360 degree range for digital video recording inside and outside of an automotive vehicle. The system has a DVR built into or connected near the camera housing and the camera housing has slot adapted to receive a compact flash (cf) card or a media card so that the images recorded by the cameras can be placed on the cf card. Also included is an optional built in microphone with a control switch for law enforcement and military purposes.

### RELATED APPLICATION

The present application is a continuation in part application of U.S. patent application Ser. No. 11/064,613 filed on Feb. 24, 2005 which in turn is a continuation in part application of U.S. patent application Ser. No. 10/227,170 filed on Aug. 23, 2002 which in turn is a continuation of U.S. patent application Ser. No. 10/186,544 filed on Oct. 17, 2002 and which in turn is a continuation in part application of U.S. patent application Ser. No. 10/005,380 filed on Dec. 3, 2001 which in turn is a continuation in part application Ser. No. 09/494,060 filed on Jan. 28, 2000 which has issued as U.S. Pat. No. 6,333,759 and which in turn is a continuation in part of Provisional U.S. Patent Application Ser. No. 60/124,624 filed on Mar. 16, 1999 and for which priority is claimed under 35 USC 120. This is a Nonprovisional Application of Provisional Application Ser. No. 61/208,866 by Joseph J. Mazzilli, filed Feb. 28, 2009.

### BACKGROUND OF THE INVENTION

1. Field of the Invention

The present invention relates to a video camera system in an automobile. In particular the present invention relates to a video camera which has a 360 degree range for video recording inside and outside of an automotive vehicle and thereby providing documentation for police officers or vehicle owners. In particular the present invention provides for a DVR or digital video recorder that is either built into the rear view mirror housing that also serves as the camera housing or alternatively is located next to and connected to the rear view mirror housing. The rear view mirror housing serving as the camera housing also has a slot adapted to accommodate the insertion of a compact flash card so that recorded camera images by the present invention can be placed on the compact flash (cf) card and/or a media card. Also included is an optional built in microphone with a control switch for law enforcement and military purposes. When the control switch is flipped or set to the on mode the microphone is activated and conversations can be recorded along with the video imaging that is being recorded by the cameras. This is useful for police and military purposes, e.g. evidentiary purposes after advising of legal rights by law enforcement or in covert operations.

2. The Prior Art

The use of videotaping systems for an automobile is known. U.S. Pat. No. 4,789,904 relates to a vehicle mounted surveillance system. The system has a camera and a control head inside a police vehicle and a video recorder in a bullet proof, fire proof vault of the vehicle.

The system is used as a surveillance system to videotape located in the trunk of a vehicle.

It would be preferred to have a system with a 360 degree range for video taping a 360 degree area simultaneously thus videotaping both inside and outside of the vehicle. It would be preferable to be able to retract the camera when not in use.

### SUMMARY OF THE INVENTION

It is a principal object of the present invention to provide a video camera system for documentary videotaping in a 360 degree range around the camera's location.

It is another object to provide a 360 degree range camera to be located behind and underneath the rear view mirror of an automobile vehicle.

It is a further object to VCR (video-cassette recorder) for ready image.

It is another object to provide a commercial VCR system which operates off the automotive vehicle's battery.

It is still another object to locate the multiplexer and VCR either inside a glove compartment or a trunk of the automotive vehicle.

It is a further object to provide a video camera system which provides a 360 degree simultaneous video taping documentation for police officers to serve as evidence for appropriate situations when vehicles and/or individuals are within range of the police officer's vehicle.

It is still another object to provide a video camera system which provides a 360 degree simultaneous video taping documentation for vehicle owners to serve as evidence of vehicle theft or police abuse that occur within range of the owner's vehicle.

It is yet another object to provide a video camera system which provides a 360 degree simultaneous video taping documentation for vehicle owners to serve as documentation of accidents and injuries and for related insurance purposes therefore that occur within range of the owner's vehicle.

Other objects will become readily apparent from the foregoing description and accompanying drawings in which:

### BRIEF DESCRIPTION OF THE DRAWINGS

FIG. 1 is a top view of the present invention;

FIG. 2 is a view of the monitor along line 2 of FIG. 1;

FIG. 3 is a partial sectional view along lines 3-3 of FIG. 1;

FIG. 4 is a partial sectional view of line 4-4 of FIG. 3; and

FIG. 5 is an alternative embodiment of the invention in which the camera has a circularly-shaped housing; and

FIG. 6 is another alternative embodiment of the present invention in which the camera has a cube-shaped housing;

FIG. 7 is another alternative embodiment of the present invention in which each of four cameras can be built into the mirror or mirror housing of the rear view mirror on different sides of the mirror so as to provide a three hundred and sixty degree view around the rear view mirror; and

FIG. 8 is a front view of the embodiment of FIG.7 in which a camera (camera 1 is built into the front surface of the rear view mirror and two other cameras (cameras 3 and 4 are built into opposite side surfaces of the rear view mirror;

FIG. 9 is a side view of the embodiment of FIG. 7 showing camera 4 built into the side surface of the rear view mirror;

FIG. 10 is a rear view of the embodiment of FIG. 7 showing a camera (camera 2) built into the rear surface of the rear view mirror; and

FIG. 11 shows another embodiment of the present invention in which a digital video recorder is built into or located and connected to the camera housing and a compact flash (cf) card can be inserted into a slot of the rear view camera housing to retrieve image data from the camera housing and onto the cf card.

### DETAILED DESCRIPTION OF THE PREFERRED EMBODIMENTS

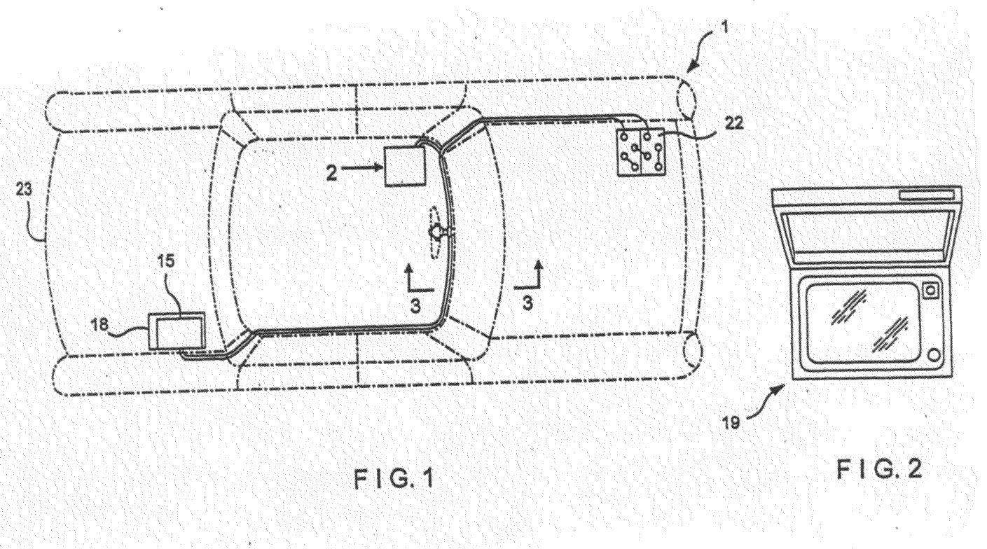

Referring to the drawings, FIG. 1 shows a top view of the invention, a 360 degree video camera system inside of an automotive vehicle 1. The 360 degree camera system includes a camera housing 5, a multiplexer unit 15 and a video cassette recorder (VCR) 18 and optionally a monitor 19, as shown in FIGS. 1 and 2.

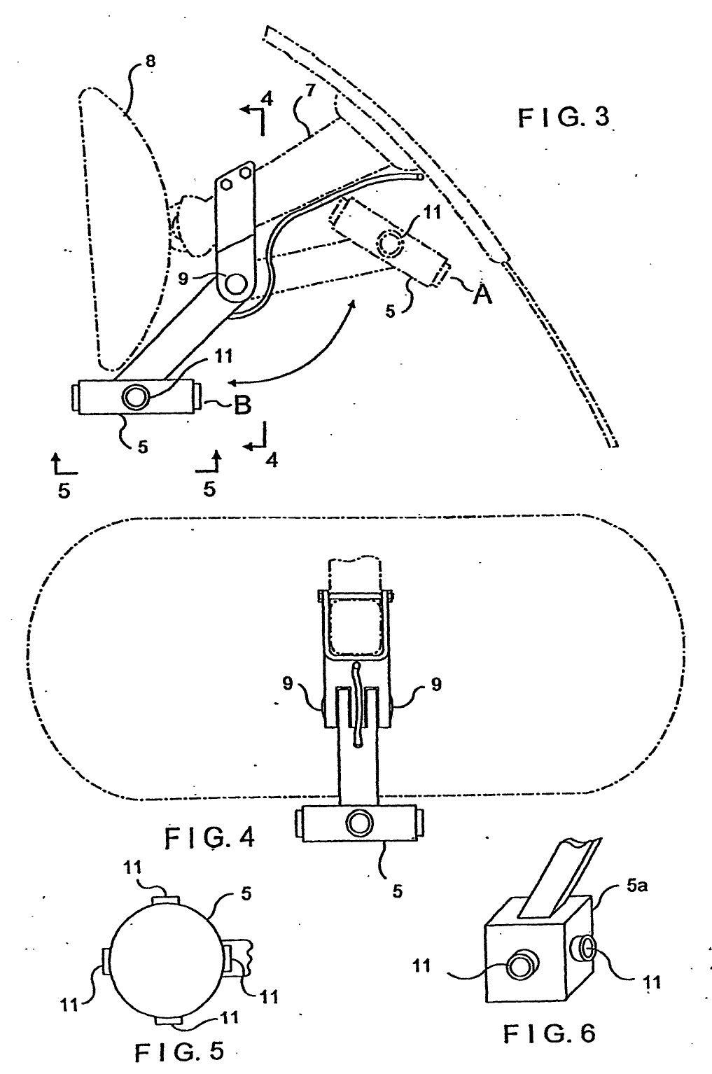

The camera housing 5, as shown in FIG. 3, can be mounted on the supporting mount 7 of the rear view mirror 8 of the automotive vehicle 1. As shown in FIG. 3, the camera housing 5 can be moved so that it can be retracted and placed behind the rear view mirror 8 in position A when not in use or extended below the rear view mirror 8 in position B when in use. A hinge mechanism 9 can articulately move the camera on its mount from position A to position B and vice verse. Alternatively other mechanical arrangements might be employed such as having the camera mount designed as a telescopic rod for extending and retracting the camera behind or below the rear view mirror respectively.

The camera housing 5 is preferably formed to accommodate a 4 Board CCD or a PC51 Series CMOS inline Micro video Camera sold by Super Circuits, Inc., Leander, Tex., which is mounted on a 1 inch to 2 inch mount giving it a 360 degree view inside and outside the vehicle. These miniature video cameras can be black and white or color cameras. It is understood, however, that any other miniature camera system can be used and the invention is not limited to these specific examples.

There is a swivel unit for the camera housing 5 which attaches to the rear view mirror.

The system includes preferably a 5 inch or 6 inch LCD video monitor for viewing the camera recorded images (FIG. 2). The monitor can be color or black and white and can flip up or down.

Wires run from the camera housing to the multiplexer which records with time and date, either in color or black and white, all four miniature video cameras at the same time. Then the wires run into a VCR which along with the miniature video cameras and multiplexer operate off the vehicle's battery 22, preferably by a wire harness (not shown) to which the wires for the miniature cameras, the multiplexer 15 and the VCR 18 run and from which the wire harness connects to the vehicle's battery 22.

Preferably, the camera housing 5 can be configured into any geometric shape and is not limited to the shapes described herein. FIGS. 3-5 shows the camera housing as a ring shaped or circular housing with lenses on each side. Preferably four miniature video cameras are provided on each side of the housing spaced 90 degrees apart but the number of cameras 11 can vary if desired. The miniature video cameras 11 provide the camera housing 5 with a 360 degree range for video recording everything around the camera housing 5, namely the interior of the automotive vehicle and the exterior of the automotive vehicle by recording through the windshield, side and rear windows of the automotive vehicle 1. The camera housing 5 and cameras 11 can run off the automotive vehicle's battery as shown in FIG.1.

The system includes a multiplexer 15 and a VCR 18. The multiplexer 15 permits all the recorded view from each camera 11 of the camera housing 5 to be placed together to provide a 360 degree picture. Thus in a four-camera arrangement, the multiplexer 15 provides for the four cameras' images to be placed side by side by side by side for display as recorded in the VCR 18 and displayed in the monitor 19. The VCR 18 records these images. One suitable multiplexer 15 for the present invention is Model No. DPX4 for color video taping and Model No. MX4M for black and white video taping available from Advanced Technology Video Inc. of Redmond, Wash. Of course the present invention is not limited to any one particular multiplexer model.

The multiplexer 15 and the VCR 18 are placed together and preferably stacked one on top of the other either in the trunk 22 of the automotive vehicle as shown in FIG.1 or in the glove compartment of the automotive vehicle (not shown).

The wiring between the camera housing 5, the multiplexer 15 and VCR 18 and optionally the monitor 19 can be placed behind the panels of the sidewalls, roof and dashboard of the vehicle as shown in FIG. 1 to keep the installation of the present invention less intrusive and the wiring concealed for aesthetic appearances. The monitor 19, VCR 18 and the multiplexer 15 can also run off the automotive vehicle's battery 22. Thus, preferably, all four video cameras 11, the multiplexer 15 and the VCR 19 have wires running to a wire harness which is connected to the vehicle's battery 22. Alternatively any other power supply can be provided such as batteries for the camera, multiplexer and VCR.

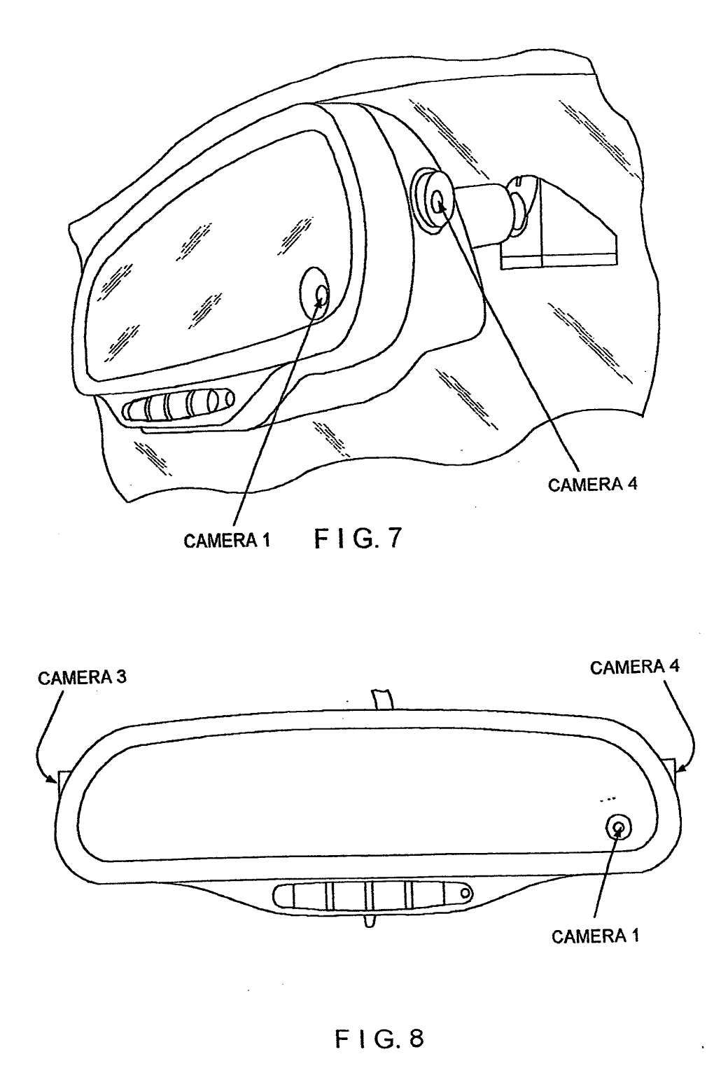

Alternatively, the camera housing 5 can be part of the housing of the rear view mirror. In other words, the camera housing can be incorporated or built into the housing of the rear view mirror (See the embodiment described below with reference to FIGS. 7-10).

In another embodiment(not shown), the miniature video camera can be a miniature digital camera and instead of a multiplexer unit and a VCR, the miniature digital camera would be wired into digital recording system. The digital recording system would be located in either the glove compartment or the trunk in place of the multiplexer unit and the VCR and similarly the miniature digital camera would be located as described for the location of the camera and camera housing 5 herein. Examples of digital video cameras that can be used in the present invention include but are not limited to JVC DVM 90 and F.Sony DCRPC 9. Examples of digital video cameras that can be used include but are not limited to Sony GVD 300, Sony GVD 600 and Mobil view II Digital Recorder. The digital recorder system or DVR will record all the images received by the cameras preferably simultaneously.

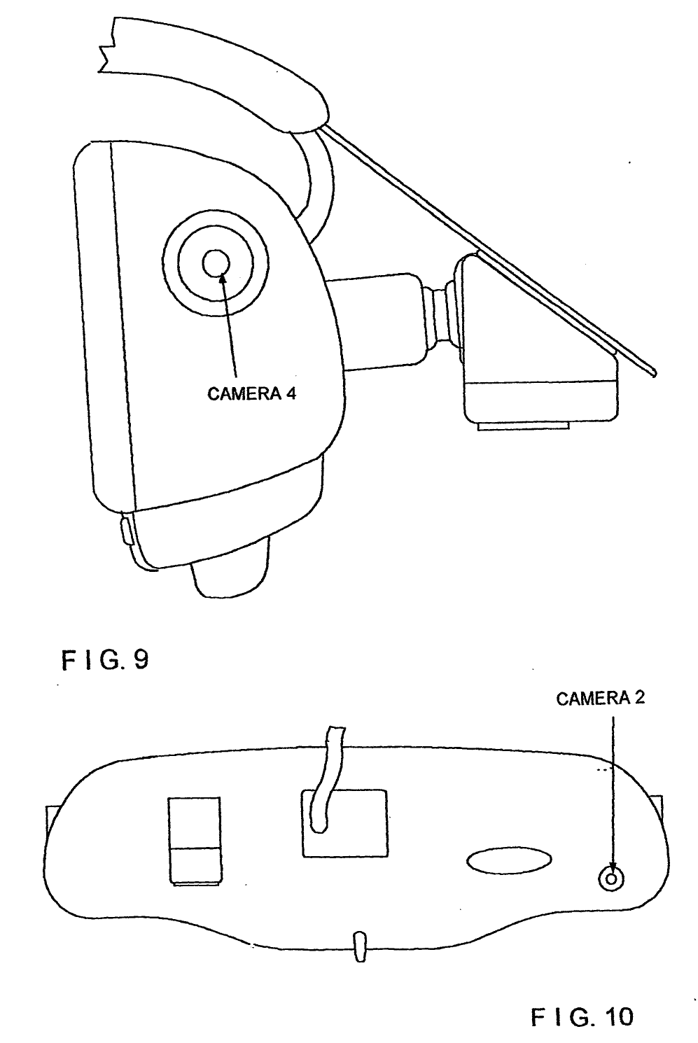

In still another embodiment of the present invention a miniature 4 camera system can be built into the rear view mirror or its housing. As shown in FIGS. 7-10 four cameras (cameras 1, 2,3 and 4) are built into the rear view mirror. As seen in FIG. 7 Camera 1 is built into the front surface of the rearview mirror and cameras 3 and 4 are built into the opposite side surfaces of the rear view mirror(see FIGS. 8 and 9). FIG. 10 illustrates that another camera, camera 2 is built into the rear side of the rear view mirror. Thus the four cameras built into the rear view mirror provide for a three hundred and sixty degree viewing around the rear view mirror. Further a monitor can be installed and attached to the rear view mirror which can flip down from the mirror for viewing. It is understood that the present invention is not limited to the number of cameras shown or the specific locations illustrated in the drawings. Alternately, the monitor can be located elsewhere in the automotive vehicle (not shown). One or more of these miniature camera system are custom designed by SVS (Subsea Video Systems, Inc.) having an address in Elizabeth City, N.C. These miniature camera system has the following specifications:
Miniature 4 day/night cameras, rear view mirror, in car video system externally mounted-clip-on version with 480 lines of high resolution, flip down color LCD view screen (the flip down monitor) with camera switcher (1-5 cameras): Pickup element: ⅓″ CCD, Snc: Internal; AGC: Automatic; Video Output: Composite (1vp-p); white balance: automatic; minimum illumination: 0.3lux., 0.0 lux; voltage: 10-16 V DC, 150 mA; Dimensions: 1.75 Dia.×2.5 inches Lg.; Weight: 154 grams; shock: Above 1000 g; Temperature: −40 degrees C. to +50 degrees C.; Lens face: Pyrex tempered.

A high resolution 16× color zoom camera is also being custom built by SVS for the present invention with the following specifications:

This high resolution color day/night camera offers a remote controlled motorized or manual zoom lens with a 16× zoom to 3.9 to 54.6 mm. The lens also incorporates an auto focus feature thereby minimizing control functions. The remote zoom control unit is also included with the camera. As with all our cameras the AV-Z is waterproof and rated to our minimum specification of 300 foot water depth. The micro lens motors do not allow for 1000 g shock levels but with the specialized camera hardening techniques it can still achieve an impressive 150 g continuous shock at 0.5 millisecond, still exceeding any other standard video camera specifications. An optional RS-232 serial data port is available for full computer control with over 10 controllable functions. This system provides for a true harsh environmental video camera.

The specifications for this camera system include:
Pickup element: ¼″ CCD, Snc: Internal; AGC: Automatic; Video Output: Composite (1vp-p); white balance: automatic; minimum illumination: 0.01 lux.; voltage: 10-16 V DC, shock: 150 g; Temperature: −40 degrees C. to +50 degrees C.; Lens face: Pyrex tempered.

A further embodiment which may utilize the camera systems such as those which are being custom built by SVS manufactured utilizes a DVR or digital video recorder as the digital recording system and does not require a multiplexer in the present invention. The camera system can either be wired for transmission to the DVR or can communicate with the DVR by wireless transmission. The DVR can be located in the automotive vehicle or at a remote location from the automotive vehicle so that the camera system can communicate with the DVR by wireless transmission. Again one version of this DVR is being custom built by SVS as a portable/mobile video recorder having the following features; broadcast quality MPEG 1 and 2 recording, 1-5 cameras, 30FPS; Programable e video compression for, optimum recording; 1 channel audio recording with wearable, wireless microphone (600′ transmission from car); instant replay of 1-5 cameras while still recording; compatible with NTSC or PAL; simple VCR like wearable wireless remote operation; computer/Internet accessible with secure password protection and up to 30 days recording with the aforementioned camera systems being custom built by SVS.
The specifications include:
ISO/IEX 13188-3,2(MPEG-2); Stream Types: Elementary, Program and Transport, Half PEL accuracy; Video Encoder: Horizontal Resolution-720,640,480,320,160; Vertical Resolution-480,240,112(NTSC), 576,288, 144 (PAL); Preprocessor: programmable 2D (7×6) filter spatial noise reduction; Motion Estimation: Pand B-pictures +/−100 (H)×+/−34 (V); Inputs: (a) Composite Video: 1×, Input Impedance: 75 Ohm, 1.0Vp-p Standards 525/60 (NTSC), 625/50 (PAL); Audio: 1×; Balanced Level—Up to 3V p-p.

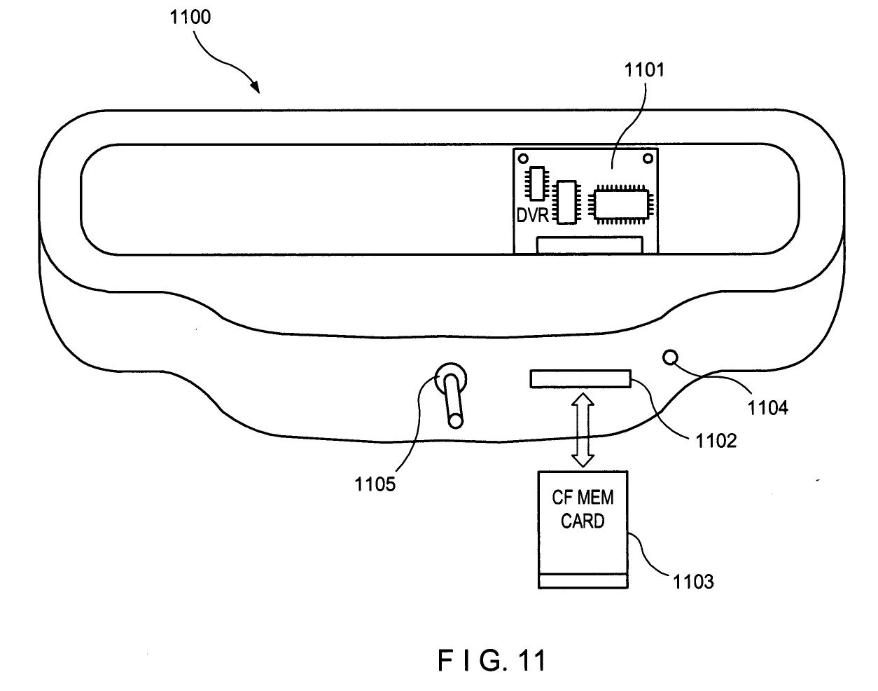

In FIG. 11, another embodiment of the present invention is shown. In this embodiment a DVR or digital video recorder 1101 that is either built into the rear view mirror housing 1100 that also serves as the camera housing 1100 or alternatively is located next to and connected to the rear view mirror housing 1100. The rear view mirror housing 1100 serving as the camera housing 1100 also has a slot 1102 adapted to accommodate the insertion of a compact flash card 1103 so that recorded camera images by the present invention can be placed on the compact flash (cf) card 1103 or a media card. Also included is an optional built in microphone 1104 with a control switch 1105 for law enforcement and military purposes. When the control switch 1105 is flipped or set to the on mode the microphone 1104 is activated and conversations can be recorded along with the video imaging that is being recorded by the cameras. This is useful for police and military purposes, e.g. evidentiary purposes after advising of legal rights by law enforcement or in covert operations.

Further the microphone 1104 and control switch 1105 can be incorporated into the camera housing structures described in the embodiments of FIGS. 3-5 where the camera housing is in the shape of a geometric configuration such as a cube, etc. and is near the rear view mirror housing (not shown).

Although the invention is described in particular for use in automotive vehicles, it can also be utilized in other vehicles involving but not limited to aircrafts, boats, trains, etc.

While presently preferred embodiments have been described for purposes of the disclosure, numerous changes in the arrangement of method steps and apparatus parts can be made by those skilled in the art. Such changes are encompassed within the spirit of the invention as defined by the appended claims.

1. A video system for an automotive vehicle, comprising:
a camera housing located inside an automotive vehicle including a plurality of cameras, located on each side of said housing to provide a 360 degree range for video recording images received by said cameras, said camera housing being incorporated into a rear view mirror of said vehicle;
a digital video recorder (DVR) for digitally recording all recorded images received from said cameras, said DVR being either built into or located next to and connected to said camera housing thereby providing a recording of a 360 degree environment surrounding said camera housing, said camera housing including a slot adapted to receive a either a compact flash (CF) memory card or a memory card therein to retrieve and record images from said camera onto said cf card or said media card.

2. The video system according to claim 1 wherein said cameras transmit said recorded images to a cf card or media card.

3. The video system according to claim 1 wherein said system further includes a microphone and a control switch that so that said control switch can be flipped to an on mode to activate said microphone so that said microphone can record conversations.

4. The video system according to claim 1 wherein said camera housing is near but separate from said mirror housing and said camera housing is shaped in a geometric configuration and a microphone and a control switch are built into said camera housing.

5. A method for digital video recording within an automotive vehicle, the steps comprising:
locating a camera housing inside an automotive vehicle including a plurality of cameras located on each side of said housing to provide a 360 degree range for video recording images received by said cameras, said camera housing being part of a housing of a rear view mirror of said vehicle;
digitally recording images by means of a digital video recorder (DVR)for digitally recording all recorded images received from said cameras, building or locating said DVR either or located next to and connected to said camera housing thereby providing a recording of said camera housing, providing a slot in said camera housing adapted to receive a compact flash (CF) memory card or a media card therein to retrieve and record images from said camera onto said cf card or a media card of a 360 degree environment surrounding said camera housing.

6. The method according to claim 5 wherein said plurality of cameras are built into said rear view mirror so that said rear view mirror is said camera housing for said cameras.

7. The method according to claim 5 wherein said cameras transmit said recorded images to a cf card or a media card.

8. The video system according to claim 1 wherein said system further includes a microphone and a control switch that so that said control switch can be flipped to an on mode to activate said microphone so that said microphone can record conversations.
